(19) United States
(12) Patent Application Publication
(10) Pub. No.: US 2013/0234911 A1
(43) Pub. Date: Sep. 12, 2013

(54) MOBILE COMMUNICATION TERMINAL WITH IMPROVED ISOLATION

(71) Applicant: PANTECH CO., LTD, Seoul (KR)

(72) Inventor: Hu-Jang LEE, Seoul (KR)

(73) Assignee: Pantech Co., Ltd, Seoul (KR)

(21) Appl. No.: 13/787,299

(22) Filed: Mar. 6, 2013

(30) Foreign Application Priority Data
Mar. 7, 2012 (KR) 10-2012-0023171

(51) Int. Cl. H01Q 21/28

(52) U.S. Cl. CPC H01Q 21/28
USPC 343/893

(57) ABSTRACT

A terminal includes a main ground disposed on a substrate, a first antenna connected to the main ground, a second antenna spaced apart by a reference distance from the first antenna and connected to the main ground, and a dummy pattern disposed within a reference proximity to at least one of the first antenna and the second antenna

### CROSS-REFERENCE TO RELATED APPLICATION

This application claims priority from and the benefit under 35 U.S.C. §119(a) of Korean Patent Application No. 10-2012-0023171, filed on Mar. 7, 2012, the entire disclosure of which is incorporated herein by reference for all purposes.

### BACKGROUND

1. Field

The following description relates to a terminal, and more particularly, to a terminal with a plurality of antennas capable of improving isolation between the antennas.

2. Discussion of the Background

With development of wireless communication technologies, an antenna system installed in a mobile terminal is becoming more diversified and includes a large number of antennas. Accordingly, a problem of deterioration in communication quality due to interference between various antennas is becoming to more apparent. For resolving the problem, isolation between antennas has to be improved.

With provisioning of voice communication services and high-quality multimedia services through a mobile communication terminal, studies to converge such services with a next-generation wireless communication service, such as Long Term Evolution (LTE) are actively conducted. However, the LTE technology requires a larger number of antennas. Generally, a mobile communication terminal uses an Inverted F Antenna (IFA) having poor isolation since antenna elements share a common ground. In order to improve isolation between antenna elements, a method for increasing distances between the individual antenna elements has been proposed, however, it may be difficult to apply the proposed method in a smaller-sized and/or slimmer terminals, which provides a limited space for antenna elements.

In order to describe interference between antennas, interference between a main antenna and a Global Positioning System (GPS) antenna, as an example, will be described.

In a general LTE terminal, a main antenna may use a frequency band from 700 megahertz (MHz) to 800 MHz as a resonance frequency band with respect to a low band, such as a first LTE band 13, a second LTE band 14, and a GPS antenna that may use a frequency band of 1575 MHz as a resonance frequency band. Here, the harmonics of a resonance generated at 700 MHz to 800 MHz inflow frequency bands of 1400 MHz through 1600 MHz, 2100 MHz through 2400 MHz, . . . , which may be multiples of the frequency band ranging from 700 MHz to 800 MHz, although the magnitudes of the harmonics may be attenuated.

Accordingly, the resonance frequency band of the GPS antenna is influenced by the main antenna, which may deteriorate the transmission/reception quality of the GPS antenna. In order to reduce such interference, as described above, the GPS antenna may need to be separated from the main antenna as far as possible. However, there are difficulties in sufficiently increasing a separation distance between the GPS antenna and the main antenna due to a limited interior space in a terminal. Therefore, in consideration of the recent popularization of slimmer mobile terminals, a method that can improve isolation between antennas in a limited interior space of the terminal is needed.

### SUMMARY

Exemplary embodiments of the present invention provide to a terminal with a plurality of antennas capable of improving isolation between the antennas.

Additional features of the invention will be set forth in the description which follows, and in part will be apparent from the description, or may be learned by practice of the invention.

Exemplary embodiments of the present invention provide a terminal including a main ground disposed on a substrate; a first antenna connected to the main ground; a second antenna spaced apart by a reference distance from the first antenna and connected to the main ground; and a dummy pattern disposed within a reference proximity to at least one of the first antenna and the second antenna.

Exemplary embodiments of the present invention provide a terminal including a main ground disposed on a substrate; a first antenna connected to the main ground; a second antenna spaced apart by a reference distance from the first antenna and connected to the main ground; a first dummy pattern disposed within a reference proximity to the first antenna; a second dummy pattern disposed within a reference proximity to the second antenna; and a is switching device to turn on at least one of the first dummy pattern and the second dummy pattern.

Exemplary embodiments of the present invention provide a method for improving isolation including determining whether a first antenna is to be used; determining whether a second antenna is to be used; determining whether the first antenna and the second antenna of a terminal uses adjacent frequency bands; and connecting a dummy pattern corresponding to the second antenna to a main ground.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a circuit diagram illustrating a general terminal with a first antenna and a second antenna.

FIG. 2 illustrates an antenna system installed in a terminal according to an exemplary embodiment of the present invention.

FIG. 3 illustrates an antenna system installed in a terminal according to an exemplary embodiment of the present invention.

FIG. 4 illustrates an arrangement structure of a dummy pattern and a first antenna according to an exemplary embodiment of the present invention.

FIG. 5 illustrates an arrangement structure of a dummy pattern and a second antenna according to an exemplary embodiment of the present invention.

FIG. 6 is a circuit diagram illustrating an arrangement structure in which a dummy pattern is coupled with a first antenna according to an exemplary embodiment of the present invention.

FIG. 7 is a rear view of a terminal having an arrangement structure in which a dummy pattern is coupled with a first antenna according to an exemplary embodiment of the present invention.

FIG. 8 is a graph illustrating an improved result of isolation when the arrangement structure of FIG. 6 is used.

FIG. 9 is a circuit diagram illustrating an arrangement structure in which a dummy pattern is coupled with a second antenna according to an exemplary embodiment of the present invention.

FIG. 10 is a rear view of a terminal having an arrangement structure in which a dummy pattern is coupled with a second antenna according to an exemplary embodiment of the present invention.

FIG. 11 is a graph illustrating an improved result of isolation when the arrangement structure of FIG. 9 is used.

FIG. 12 is graphs illustrating improved results of isolation when the structure of FIG. 1 is compared to the arrangement structures of FIG. 6 and FIG. 9, respectively.

FIG. 13 is a table storing comparative antenna characteristics in a resonance is frequency band of a second antenna corresponding to the arrangement structure of FIG. 6 and a second antenna corresponding to the arrangement structure of FIG. 9.

FIG. 14 is a circuit diagram illustrating a terminal with a plurality of antennas according to an exemplary embodiment of the present invention.

FIG. 15 is a flowchart illustrating a method for connecting dummy patterns of a terminal to a main ground according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that when an element is referred to as being “on” or “connected to” or “coupled to” another element, it can be directly on, directly connected to, or directly coupled to the other element, or intervening elements may be present. In contrast, if an element is referred to as being “directly on” or “directly connected to” or “directly coupled to” another element, no intervening elements are present. Further, it will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

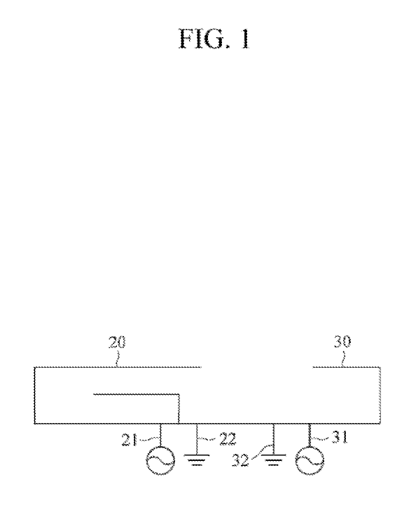

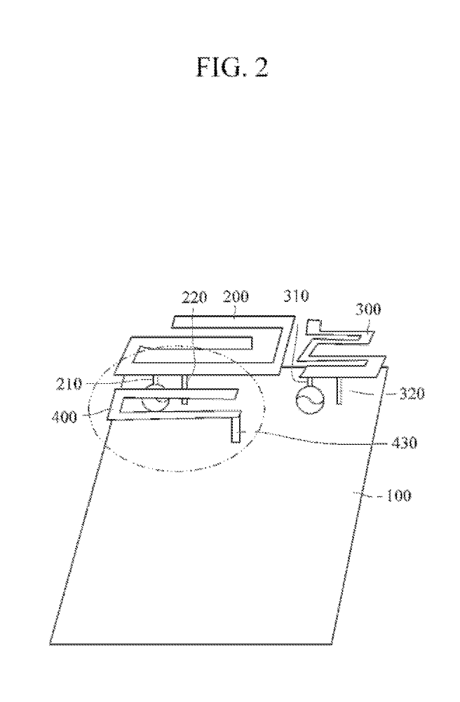

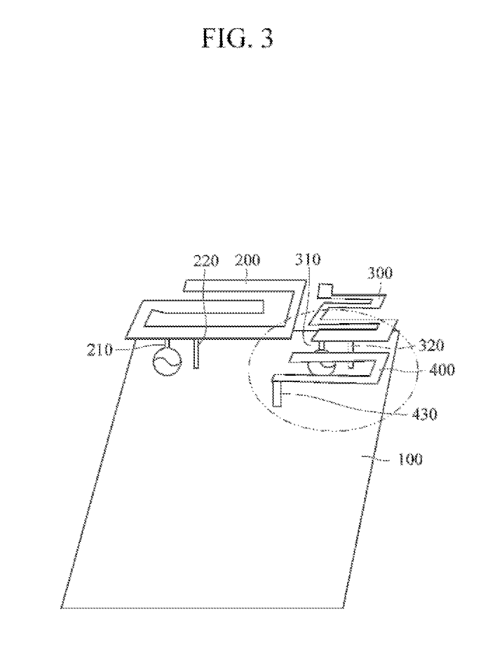

FIG. 1 is a circuit diagram illustrating a general terminal with a first antenna and a second antenna. FIG. 2 illustrates an antenna system installed in a terminal according to an exemplary embodiment of the present invention. FIG. 3 illustrates an antenna system installed in a terminal according to an exemplary embodiment of the present invention.

Referring to FIG. 1, a general terminal includes a main ground that grounds antennas, a first antenna 20 and a second antenna 30 that may be commonly connected to the main ground. The first antenna 20 and the second antenna 30 may support the same resonance is frequency band or different resonance frequency bands. The general terminal may also include a first feeding line 21 to connect the first antenna 20 to a signal source of the substrate, a first ground feeding line 22 to connect the first antenna 20 to a ground of the substrate, a second feeding line 31 to connect the second antenna 30 to the signal source of the substrate, and a second ground feeding line 32 to connect the second antenna 30 to the ground of the substrate.

Referring to FIG. 2 and FIG. 3, a terminal includes a main ground 100 disposed on a substrate, a first antenna 200 connected to the main ground 100, a second antenna 300 spaced apart by at least a reference distance from the first antenna 200 and connected to the main ground 100, and a dummy pattern 400. The dummy pattern 400 may be disposed to be coupled with at least one of the first antenna 200 and the second antenna 300. The dummy pattern 400 may be disposed within a reference proximity to at least one of the first antenna 200 and the second antenna 300 to provide a coupling resonance with at least one of the first antenna 200 and the second antenna 300.

Further, the second antenna 300 may be disposed at the reference distance in a direction perpendicular to a direction in which the main ground 100 extends. However, aspects of the invention are not limited thereto, such that the second antenna 300 may be disposed at the reference distance in a direction parallel to a direction in which the main ground 100 extends. Further, referring again to FIG. 2 and FIG. 3, although the dummy pattern 400 is illustrated to be disposed at a lower side or a first side of the first antenna 200 and the second antenna 300, aspects of the invention are not limited thereto, such that the dummy pattern 400 may be disposed at any side of the first antenna 200 and the second antenna 300. Further, the dummy pattern 400 may also be disposed below or above the first antenna 200 and the second antenna 300.

The main ground 100 may be disposed, as described above, on the substrate of the terminal. In an example, the substrate itself may operate as the main ground 100. The main ground 100 may be disposed in the shape of rectangle. However, aspects of the invention are not limited thereto, such that the main ground 100 may be formed in a triangle, a circle, or other geometrical shapes.

The first antenna 200 and the second antenna 300 are disposed on the main ground 100 and may receive radio frequency (RF) signals of the corresponding frequency bands, respectively. The first antenna 200 includes a first signal feeding line 210 that connects the first antenna 200 to a signal source of the substrate, and a first ground feeding line 220 that connects the first antenna 200 to a ground of the substrate. The second antenna 300 includes a second signal feeding line 310 that connects the second antenna 300 to the signal source of the substrate, and a second ground feeding line 320 that connects the second antenna 300 to the ground of the substrate.

The first antenna 200 and the second antenna 300 may be connected to the same ground or to different grounds, respectively. Also, FIG. 2 and FIG. 3 show the first signal feeding line 210 and the first ground feeding line 220 formed in the first antenna 200. Similarly, FIG. 2 and FIG. 3 show the second signal feeding line 310 and the second ground feeding line 320 formed in the second antenna 300. However, it may also be possible that a single signal feeding line or a single ground feeding line connects both of the first antenna 200 and the second antenna 300 to the circuit substrate or to the ground.

The first antenna 200 and the second antenna 300 may support similar or the same resonance frequency band or different resonance frequency bands. Referring to FIG. 2 and FIG. 3, the first antenna 200 and the second antenna 300 may support different resonance frequency bands. Further, the first antenna 200 may perform a data transmission/reception operation, which may support multiple bands including a Long Term Evolution (LTE) band. The second antenna 300 may be a GPS antenna.

The first antenna 200 based on the LTE standard may use, in a low band, a frequency band ranging from 700 megahertz (MHz) to 800 MHz, as a resonance frequency band. The second antenna 300, which may be a GPS antenna, may use a frequency band of 1575 MHz as a resonance frequency band. Accordingly, the LTE frequency band and the GPS frequency band may not interfere with one another. However, the 2nd, 3rd, . . . , nth harmonics of a resonance provided in the resonance frequency band from 700 MHz to 800 MHz of the first antenna 200 may inflow frequency bands of 1400 MHz through 1600 MHz, 2100 MHz through 2400 MHz, . . . , which may correspond to integer number multiples of the resonance frequency band. More specifically, the 2nd harmonics of a resonance provided in the resonance frequency from 700 MHz to 800 MHz of the first antenna 200 may provide inflow frequency bands of 1400 MHz through 1600 MHz, which are derived by multiplying an integer 2 corresponding to the 2nd harmonic with the resonance frequency of 700 MHz and 800 MHz. Accordingly, the 2nd harmonic of the first antenna 200, among the inflowing harmonics, may inflow a resonance frequency band of 1400 MHz to 1600 MHz, which may coincide with the frequency band of the second antenna 300 at 1575 MHz and provide interference with the second antenna 300.

The dummy pattern 400 is disposed on the main ground 100, and connected to the main ground 100 through a grounding line 430 to be grounded. The dummy pattern 400 may be disposed to provide a coupling resonance with at least one of the radiating patterns of the first antenna 200 and the second antenna 300. In providing a coupling resonance, the dummy pattern 400 may be disposed within a reference proximity to the corresponding radiating pattern.

FIG. 2 illustrates dummy pattern 400 disposed within a reference proximity to the first antenna 200 to be coupled with the first antenna 200. FIG. 3 illustrates dummy pattern 400 disposed within a reference proximity to the second antenna 300 to be coupled with the second antenna 300. Referring to FIG. 2, the dummy pattern 400 may provide a coupling resonance with the first antenna 200 located within a reference proximity to the dummy pattern 400. In more detail, the dummy pattern 400 may provide a third resonance, which may be an auxiliary or a dummy resonance used for data transmission and/or reception of at least one of the first antenna 200 and the second antenna 300, in the resonance frequency band of the second antenna 300, more specifically, an interfered antenna. Accordingly, it may be possible to prevent or reduce a likelihood of incurring harmonics of the resonance frequency band of the first antenna 200 from inflowing the frequency band of the second antenna 300, which may interfere with the second antenna 300.

The dummy pattern 400 may be configured to have a reference shape of wire, which may be disposed on a reference shape of board or other shape in correspondence to the structure of the terminal. Also, the dummy pattern 400 may not operate as an antenna since the dummy pattern 400 may not receive feeding signals. The dummy pattern 400 may operate to provide a coupling resonance with the first antenna 200 or the second antenna 300 with which the dummy pattern 400 is coupled.

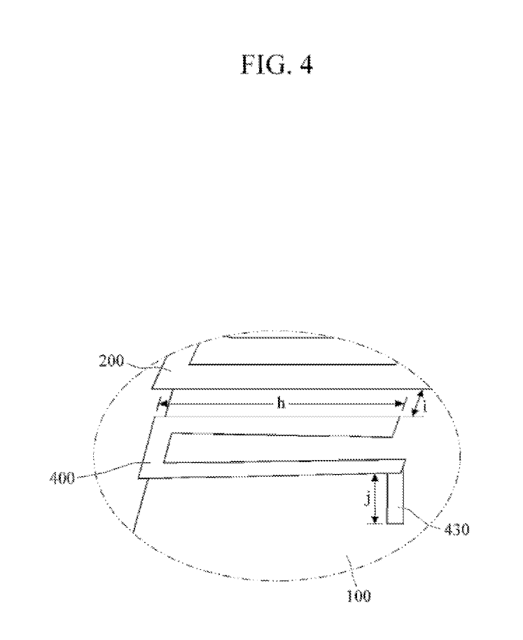

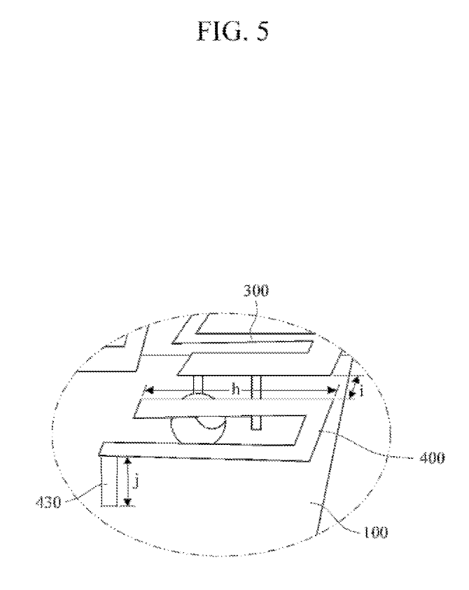

FIG. 4 illustrates an arrangement structure of a dummy pattern and a first antenna. FIG. 5 illustrates an arrangement structure of a dummy pattern and a second antenna according to an exemplary embodiment of the present invention.

According to aspects of the invention, a length h by which the dummy pattern 400 overlaps at least one of the first antenna 200 and the second antenna 300 with which the dummy is pattern 400 is coupled may be set to a length below a reference threshold, such as a minimum length, for which coupling can occur. Referring to FIG. 4 and FIG. 5, the dummy pattern 400 may provide a third resonance, which may be an auxiliary or a dummy resonance that may generally not be used for data transmission and/or reception of at least one of the first antenna and the second antenna, in the frequency band of the second antenna 300. More specifically, the dummy pattern 400 may provide a third resonance based on inductance L and capacitance C, in the frequency band of the second antenna 300. More specifically, the third resonance may be generated by adjusting at least one of a length of the dummy pattern 400, a distance j between the dummy pattern 400 and the main ground 100, and a distance i between the dummy pattern 400 and at least one of the first antenna 200 and the second antenna 300 coupled with the dummy pattern 400. The inductance L and the capacitance C may provide the LC resonance.

In more detail, by coupling the dummy pattern 400 with one of the two antennas including the first antenna 200 and the second antenna 300 that may support different frequency bands, a desired coupling resonance may be incurred due, at least in part, to inductance L based on a length h of the dummy pattern 400, which may be overlapped by the first antenna 200, and the capacitance C based on the distance j between the dummy pattern 400 and the main ground 100 and the distance i between the dummy pattern 400 and the first antenna 200. Accordingly, isolation of the corresponding frequency may be improved. The dummy pattern 400 may not operate as an antenna, although it may provide a coupling resonance with the first antenna 200 with which the dummy pattern 400 is coupled.

$$f = \frac{1}{2 π \sqrt{LC}} \qquad ( Equation 1 )$$

Referring to Equation 1, a third resonance value of the resonance frequency band of the second antenna 300 may be calculated from a L value of inductance based on a length of is the dummy pattern 400 and a C value of capacitance based on a first distance between the dummy pattern 400 and the main ground 100, and a second distance between the dummy pattern 400 and at least one of the first antenna 200 and the second 300. The dummy pattern 400 may be disposed within a reference proximity to the first antenna 200 to be coupled with the first antenna 200, or within a reference proximity to the second antenna 300 to be coupled with the second antenna 300.

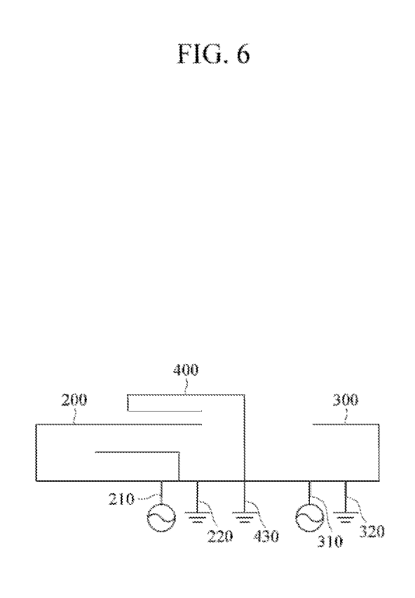

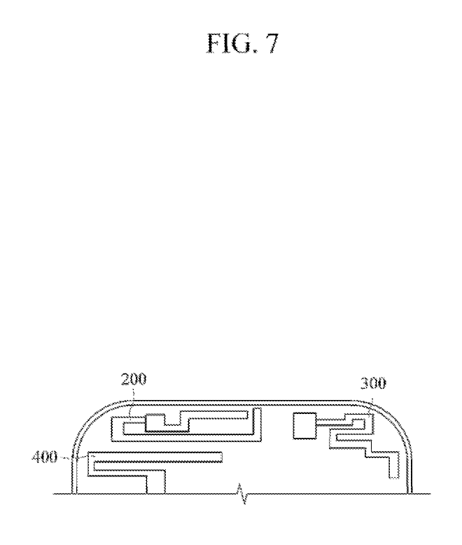

FIG. 6 is a circuit diagram illustrating an arrangement structure in which a dummy pattern can be coupled with a first antenna according to an exemplary embodiment of the present invention. FIG. 7 is a rear view of a terminal having an arrangement structure in which a dummy pattern is coupled with a first antenna according to an exemplary embodiment of the present invention. The arrangement structure illustrated in FIG. 6 and FIG. 7 may be applied to the first antenna 200 and the second antenna 300, which may support frequency bands that are distant from each other.

Referring to FIG. 6 and FIG. 7, the dummy pattern 400 may be disposed within a reference proximity to the first antenna 200 to provide a coupling resonance with the first antenna 200.

If the dummy pattern 400 is disposed within the reference proximity to the first antenna 200 and coupled with the first antenna 200, at least one of an LC resonance provided by the first antenna 200, an LC resonance provided by the second antenna 300, and a third resonance provided by the dummy pattern 400 may reduce antenna radiation of the first antenna 200 with respect to the resonance frequency band of the second antenna 300, thereby improving isolation of the corresponding frequency band. More specifically, the dummy pattern 400 may provide a third resonance in the resonance frequency band of the second antenna 300 to prevent is or reduce a likelihood of antenna radiation (i.e., the 2nd, 3rd, . . . , nth harmonics of a resonance that may be incurred in the resonance frequency band) of the first antenna 200 with respect to the resonance frequency band of the second antenna 300. Accordingly, a likelihood of interference by the first antenna 200 with respect to the resonance frequency band of the second antenna 300 may be reduced or prevented, resulting in improvement of isolation.

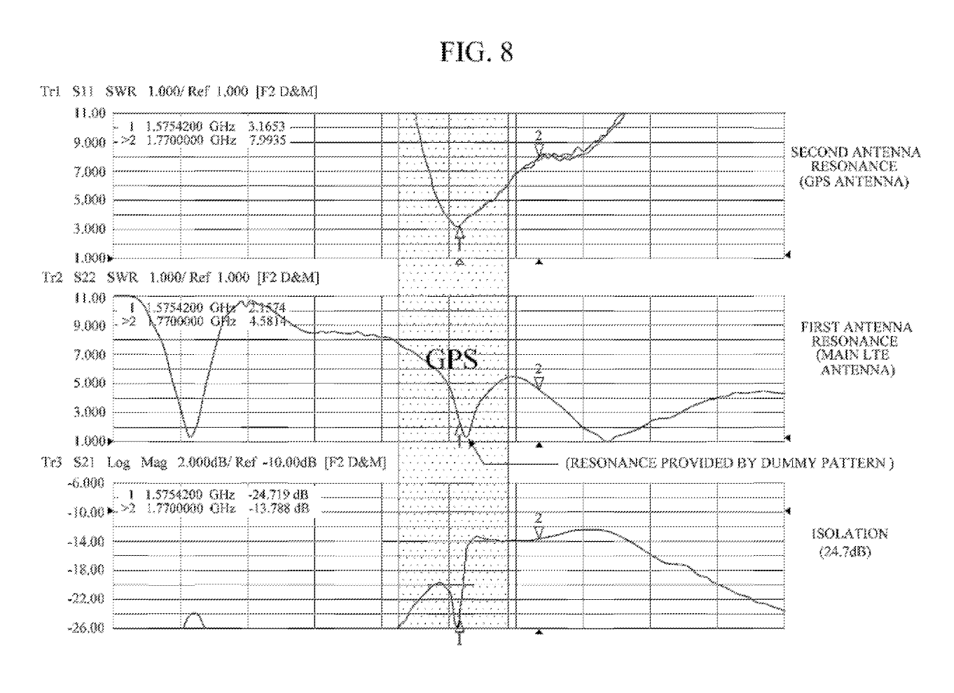

FIG. 8 is a graph illustrating an improved result of isolation when the arrangement structure of FIG. 6 is used.

For testing the improved result of isolation, inverted-F antennas have been adopted as the first antenna 200 and the second antenna 300, in which the first antenna 200 has resonance frequency band of a LTE band, and the second antenna 300 is a GPS antenna. Also, the dummy pattern 400 may be configured in the shape of a ground line and disposed within a reference proximity to the first antenna 200 to provide a coupling resonance in a GPS frequency bandwidth for the first antenna 200.

Referring to FIG. 8, it may be seen that while the first antenna 200, which may be supporting multiple bands, resonates, a resonance based on the dummy pattern 400 may be provided in the GPS frequency band. As a result, an improvement of isolation may be seen. More specifically, the isolation between the first antenna 200 and the second antenna 300 increases from 10 dB to 24.7 dB when the dummy pattern 400 is disposed within a reference proximity to the first antenna 200.

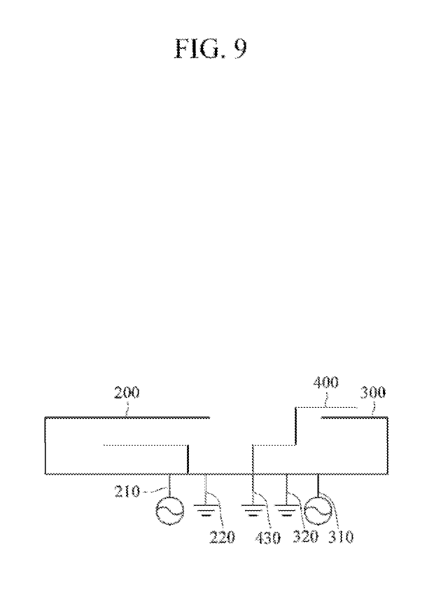

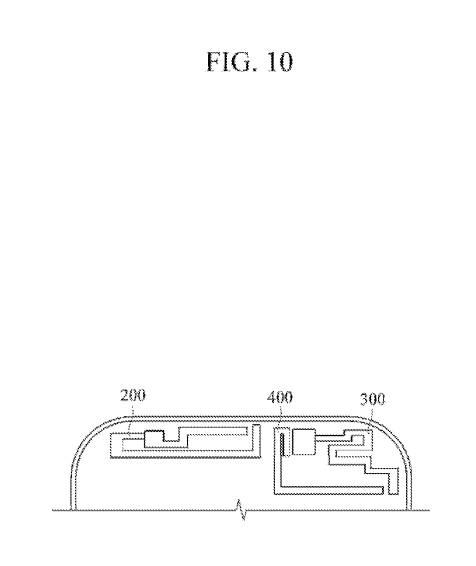

FIG. 9 is a circuit diagram illustrating an arrangement structure in which a dummy pattern is coupled with a second antenna according to an exemplary embodiment of the present invention. FIG. 10 is a rear view of a terminal having an arrangement structure in which a dummy pattern is coupled with a second antenna according to an exemplary embodiment of the is present invention. The arrangement of the dummy pattern 400 shown in FIG. 9 and FIG. 10 may be applied when the first antenna 200 and the second antenna 300 support frequency bands that are adjacent to each other.

Referring to FIG. 9 and FIG. 10, the dummy pattern 400 is disposed within a reference proximity to the second antenna 300 to be coupled with the second antenna 300. The dummy pattern 400 may provide a coupling resonance with the second antenna 300. As described above, when the dummy pattern 400 is disposed within a reference proximity to the second antenna 300 to be coupled with the second antenna 300, at least one of an LC resonance provided by the first antenna 200, an LC resonance provided by the second antenna 300, and a third resonance provided by the dummy pattern 400 may reduce antenna radiation of the second antenna. Also, even when the first antenna 200 and the second antenna 300 share the same ground, a resonance of the first antenna 200 or the second antenna 300, which the third resonance provided by the dummy pattern 400 may influence, may be attenuated toward the main ground 100, resulting in the effect of ground separation and the improvement of isolation.

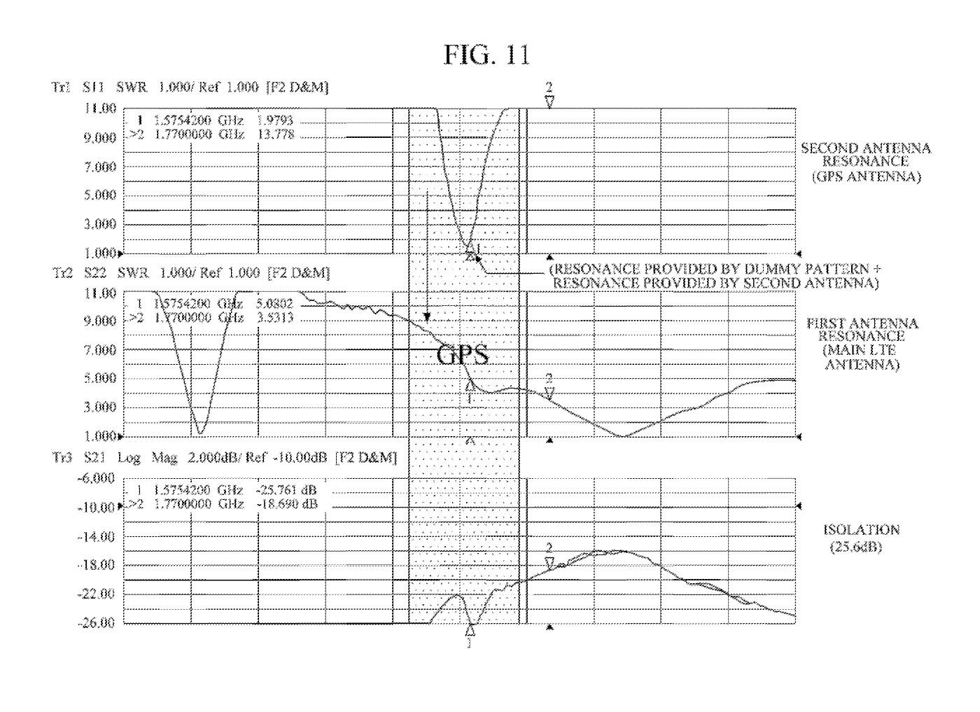

FIG. 11 is a graph illustrating an improved result of isolation when the arrangement structure of FIG. 9 is used.

For testing the improved result of isolation, inverted-F antennas have been adopted as the first antenna 200 and the second antenna 300, in which the first antenna 200 is a to main antenna whose resonance frequency band is a LTE band, and the second antenna 300 is a GPS antenna. Also, the dummy pattern 400 may be configured in the shape of a ground line and disposed within a reference proximity to the second antenna 300 to provide a coupling resonance in the GPS frequency band with the second antenna 300.

Referring to FIG. 11, a resonance provided by the second antenna 300 is added with a resonance provided by the dummy pattern 400. As a result, an improvement in isolation may be seen. More specifically, the isolation between the first antenna 200 and the second antenna 300 may increase from 10 dB to 25.6 dB in the GPS band when the dummy pattern 400 is disposed within a reference proximity to the second antenna 300.

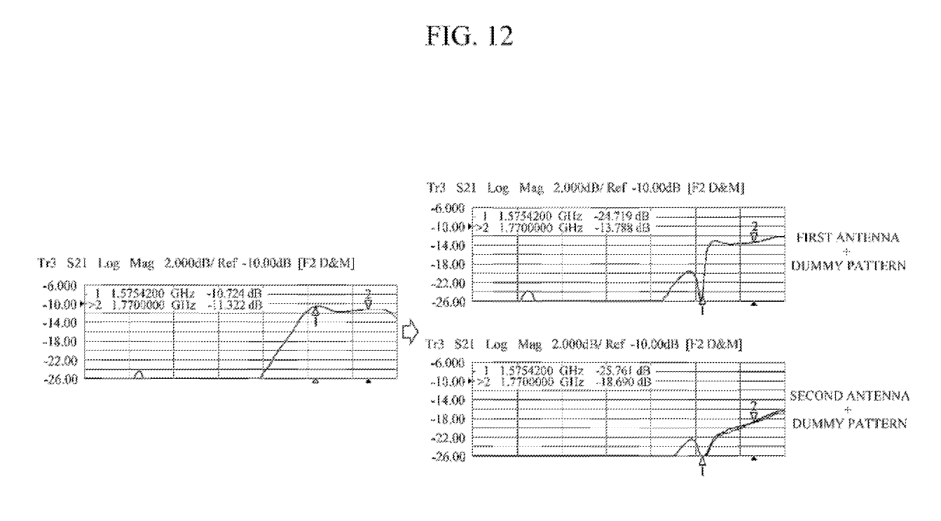

FIG. 12 is graphs illustrating improved results of isolation when the general structure shown in FIG. 1 is compared to the arrangement structures of FIG. 6 and FIG. 9, respectively.

Referring to the left graph of FIG. 12, when the first antenna 200, whose resonance frequency band corresponds to the LTE band, is disposed within a reference proximity to the second antenna 300 while no dummy pattern 400 is provided, isolation was measured to be 10 decibel (dB). Referring to the right graphs in FIG. 12, when the dummy pattern 400 is disposed within the first antenna 200 or the second antenna 300, as illustrated in the arrangement structures of FIG. 6 and FIG. 9, isolation was measured to be about 25 dB for both antennas. This result shows the improvement effect of isolation of about 15 dB. In more detail, referring to FIG. 12, when the dummy pattern 400 is coupled with the first antenna 200, the improvement of isolation reaches 14.7 dB, and when the dummy pattern 400 is coupled with the second antenna 300, the improvement of isolation reaches 15.6 dB. Accordingly, it may be possible to select an antenna that is to be coupled with the dummy pattern 400 according to a purpose of use and/or a to frequency band environment.

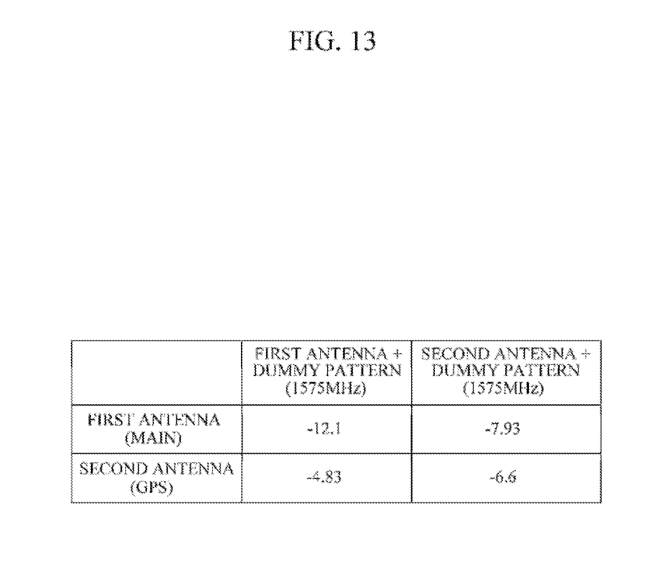

FIG. 13 is a table storing comparative antenna characteristics in the resonance frequency band of a second antenna corresponding to the arrangement structure of FIG. 6 and a second antenna corresponding to the arrangement structure of FIG. 9.

The test results of FIG. 13 show passive characteristics of the corresponding GPS is band according to the arrangement structures of FIG. 6 and FIG. 9, and correspond to three dimensional (3D) gain values expressed in unit of decibel isotropic (dBi). Resonance frequencies provided by the first antenna 200, which may be a main antenna, and the second antenna 300, which may be a GPS antenna, may act as parasitic or auxiliary components with respect to the antenna that is coupled with the dummy pattern 400 to reduce antenna energy radiation. However, the table of FIG. 13 shows that isolation is improved in a greater amount than the reduction degree of the antenna radiation.

In more detail, in the arrangement structure of FIG. 6, in which the dummy pattern 400 is coupled with the first antenna 200, the gain of the first antenna 200 is reduced by 4.17 when compared to the structure having no dummy pattern 400. However, in the GPS band, which may not be a frequency band of interest of the first antenna 200, the gain of the first antenna 200 may not influence the transmission/reception quality of the main antenna. However, isolation is shown to have improved by 14.7 dB, as shown in FIG. 8.

Also, in the arrangement structure of FIG. 9, in which the dummy pattern 400 is coupled with the second antenna 300, the gain of the second antenna 300 is reduced by 1.77 when compared to the structure having no dummy pattern 400. However, isolation is shown to have increased by 15.6 dB, as shown in FIG. 8.

As seen from the table of FIG. 13, the coupling direction of the dummy pattern 400 may influence antenna characteristics due, at least in part, to the radiation effect or parasitic or auxiliary component generation according to the flow of a current upon signal feeding. If the resonance frequency bands of the first antenna 200 and the second antenna 300 are adjacent to each other, coupling the dummy pattern 400 with the second antenna 300 may provide a GPS resonance to appear sharply in the resonance frequency band of the second antenna 300. More specifically, since the GPS resonance appears sharply, interference due to the GPS resonance may be reduced so that the performance of the first antenna 200, which may perform transmission/reception operation, may be improved. Also, if the resonance frequency bands of the first antenna 200 and the second antenna 300 are distant from each other, the performance of the second antenna 300 may be selected for improvement. Accordingly, the dummy pattern 400 may be coupled with the first antenna 200.

The first antenna 200 and the second antenna 300 may support resonance frequency bands adjacent to each other. More specifically, a high frequency band of the main antenna or the first antenna 200 may be adjacent to the resonance frequency band of the GPS antenna or the second antenna 300, such that the remaining frequency band of the first antenna 200 except for the frequency band interfered with the second antenna 300 may be adjacent to the resonance frequency band of the second antenna 300.

According to aspects of the invention, the length h by which the dummy pattern 400 overlaps at least one of the first antenna 200 and the second antenna 300 with which the dummy pattern 400 is coupled may be set to a length below a reference threshold, such as a minimum length, for which coupling can occur. As described above, a resonance frequency may be based on inductance L and capacitance C, and frequency characteristics may be based on coupling conditions. The longer the coupling length h, which may be provided between the dummy pattern 400 and at least one of the first antenna 200 and the second antenna 300, the wider bandwidth the GPS frequency band may have. Accordingly, by reducing the coupling length h to narrow the resonance bandwidth of the GPS frequency band below a reference threshold, it may be possible to reduce interference with respect to peripheral frequency bands.

The distance i between the dummy pattern 400 and at least one of the first antenna 200 and the second antenna 300 coupled with the dummy pattern 400 may be set to a distance above a reference threshold, such as a maximum distance, at which coupling can occur. The shorter the distance i between the dummy pattern 400 and at least one of the first antenna 200 and the second antenna 300 coupled with the dummy pattern 400, the wider resonance bandwidth the GPS frequency band may have. Accordingly, by increasing the distance i, the resonance bandwidth of the GPS frequency band may be narrowed so that the resonance may reduce its influence on the peripheral frequency bands. Further, the resonance bandwidth of the GPA frequency band may be narrowed below a reference threshold, such that the resonance may not influence the peripheral frequency band above a reference threshold.

The distance j between the dummy pattern 400 and the main ground 100 may be set to a distance below a reference threshold, such as a minimum distance, at which coupling can occur. Generally, antennas are designed to be spaced away from a ground, and radiation may be generated from the ends of the antenna patterns. However, since the dummy pattern 400 may not operate as an antenna, the dummy pattern 400 may be disposed at the distance j from the main ground 100 to move a resonance frequency band to a lower band, so that the length of the dummy pattern 400 can be reduced below a reference threshold.

As described above, by adjusting at least one of a width and length of the dummy pattern 400, a distance between the dummy pattern 400 and the main ground 100, and a the distance between the dummy pattern 400 and an antenna that may be coupled with the dummy pattern 400, a target resonance frequency can be provided. More specifically, at least one of the width and length of the dummy pattern 400, the distance between the dummy pattern 400 and the main ground 100, and a distance between the dummy pattern 400 and at least one of the first antenna 200 and the second antenna 300 coupled with the dummy pattern 400, may be is configured such that a third or auxiliary resonance may be provided in a resonance frequency band of an interfered antenna of at least one of the first antenna 200 and the second antenna 300.

The first antenna 200 may support multiple bands including the LTE band, and the second antenna 300 may support at least one of a GPS band, a WiFi band, and a Bluetooth® band. Also, the first antenna 200 and the second antenna 300 may support various well-known resonance frequency bands including, but not limited to, Wideband Code Division Multiple Access (WCDMA), Code Division Multiple Access (CDMA), Wibro®, fourth generation of cell phone mobile communications standards (4G), ZigBee®, Bluetooth®, and the like.

Further, at least one of the first antenna 200 and the second antenna 300 may be ones selected from among a Planar Inverted-F Antenna (PIFA), a meander antenna, a loop antenna, an Inverted-F antenna, a wire type antenna, and the like, according to a communication environment of the corresponding terminal.

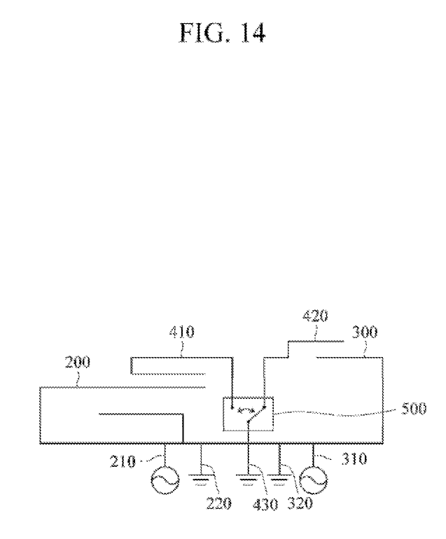

FIG. 14 is a circuit diagram illustrating a terminal with a plurality of antennas according to an exemplary embodiment of the present invention.

Referring to FIG. 14, the terminal includes a main ground 100 disposed on a substrate, a first antenna 200 connected to the main ground 100, a second antenna 300 spaced apart by a reference distance from the first antenna 200 and connected to the main ground 100, a first dummy pattern 410 disposed within a reference proximity to the first antenna 200 to be coupled with the first antenna 200 to generate a third resonance, which may be an auxiliary or a dummy resonance used for data transmission and/or reception of at least one of the first antenna 200 and the second antenna 300, in the resonance frequency band of the second antenna 300, a second dummy pattern 420 disposed within a reference proximity to the second antenna 300 to be coupled with the second antenna 300 to generate a third resonance in the resonance frequency is band of the second antenna 300, and a switching device 500. The switching device 500 is connected to the first dummy pattern 410, the second dummy pattern 420, and the main ground 100 to ground at least one of the first dummy pattern 410 and the second dummy pattern 420 to the main ground 100, so that the harmonics of a resonance of the first antenna 200 may be less likely or prevented from inflowing the resonance frequency band of the second antenna 300.

Further, since the configurations of the main ground 100, the first antenna 200, and the second antenna 300 have been described above, detailed descriptions thereof will be omitted. As described above, the first antenna 200 and the second antenna 300 may support the same resonance frequency band or different resonance frequency bands. The first antenna 200 may transmit and/or receive data and may support multiple bands including the LTE band. The second antenna 300 may be a GPS antenna.

The first dummy pattern 410 is disposed within a reference proximity to the first antenna 200 to be coupled with the first antenna 200 and provide a third resonance in the resonance frequency band of the second antenna 300. The second dummy pattern 420 is disposed within a reference proximity to the second antenna 300 to be coupled with the second antenna 300 and provide a third resonance in the resonance frequency band of the second antenna 300. As such, the first dummy pattern 410 and the second dummy pattern 420 may be used to prevent or reduce the likelihood of the harmonics of a resonance of the first antenna 200 to from inflowing the resonance frequency band of the second antenna 300 and generating interference with the second antenna 300. Each of the first dummy pattern 410 and the second dummy pattern 420 may be configured in a reference shape of wire, in a reference shape of board, or in any other shape in correspondence to the structure of the terminal.

The switching device 500 is connected to the first dummy pattern 410 and the is second dummy pattern 420 and the main ground 100. The switching device 500 may select at least one of the first dummy pattern 410 and the second dummy pattern 420 to ground the selected dummy pattern to the main ground 100. The switching device 500 is connected to the main ground 100 through a ground line 430, and may electrically connect/disconnect at least one of dummy patterns, including the first dummy pattern 410 and the second dummy pattern 420, to/from the main ground 100. The switching device 500 may be a Single Ple Double Throw (SPDT) switch, a PIN switch, or the like. By turning on/off the switching device 500 to selectively connect the first dummy pattern 410 and the second dummy pattern 420 to the main ground 100, it may be possible to improve the quality of wireless communication adaptively according to a wireless communication environment.

Further, each of the first dummy pattern 410 and the second dummy pattern 420 may provide a third resonance of the frequency band of the second antenna 300. More specifically, the third resonance may be provided through a LC resonance resulting from inductance L based on a length of the first dummy pattern 410 or the second dummy pattern 420, and capacitance C based on a distance between at least one of the dummy patterns, including the first dummy pattern 410 and the second dummy pattern 420, and the main ground 100 or at least one of the antennas, including the first antenna 200 and the second antenna 300. As described above, by connecting at least one of the two dummy patterns, including the first dummy pattern 410 and the second dummy pattern 420 supporting different frequency bands, to the main ground 100 to provide a target coupling resonance. The target coupling resonance may have an inductance based on a length h by which at least one of the first dummy pattern 410 and the second dummy pattern 420 overlaps an antenna coupled with at least one of the first dummy pattern 410 and the second dummy pattern 420, and a capacitance based on a distance between at is least one of the dummy patterns, including the first dummy pattern 410 and the second dummy pattern 420, and the main ground 100 and a distance between an antenna and at least one of the dummy patterns. Accordingly, isolation of the corresponding frequency can be improved.

According to aspects of the invention, at least one of the first antenna 200 and the second antenna 300 may support frequency bands that are distant from each other, and the switching device 500 connects the first dummy pattern 410 to the main ground 100.

As described above, if the first dummy pattern 410 is connected to the main ground 100 so that the first antenna 200 is coupled with the first dummy pattern 410, at least one of a LC resonance of the first antenna 200, a LC resonance of the second antenna 300, and a third resonance of the first dummy pattern 410 may be provided to reduce antenna radiation of the first antenna 200 with respect to the resonance frequency band of the second antenna 300, thereby improving isolation. More specifically, the first dummy pattern 410 may provide a third resonance in the resonance frequency band of the second antenna 300 to reduce antenna radiation of the first antenna 200 with respect to the resonance frequency band of the second antenna 300, thereby preventing interference of the first antenna 200 with respect to the resonance frequency band of the second antenna 300, resulting in improvement of isolation.

Referring to FIG. 14, arrangement structure of FIG. 14 may be configured to be structurally similar or the same as the arrangement structure of FIG. 6 where a dummy pattern 400 is disposed within a reference proximity to the first antenna 200 and no dummy pattern is disposed within the reference proximity to the second antenna 300. Accordingly, the arrangement structure of FIG. 14 described above can acquire the same or similar test results as the improved results of isolation shown in FIG. 8, and also it can be expected that isolation between the first antennas 200 and the second antenna 300 may increase from 10 dB to 24.7 dB is in the GPS band.

According to aspects of the invention, the first antenna 200 and the second antenna 300 may support the same or adjacent frequency bands, and the switching device 500 may connects the second dummy pattern 420 to the main ground 100.

As described above, when the second dummy pattern 420 is connected to the main ground 100 so that the second antenna 300 is coupled with the second dummy pattern 420, at least one of a LC resonance of the first antenna 200, a LC resonance of the second antenna 300, and a third resonance provided by the second dummy pattern 420 may be provided to reduce antenna radiation of the second dummy pattern 420. Also, even when the first antenna 200 and the second antenna 300 share the same ground, a resonance of at least one of the first antenna 200 and the second antenna 300, which the third resonance provided by the second dummy pattern 420 influences, may be attenuated toward the main ground 100, resulting in the effect of ground separation and the improvement of isolation.

The arrangement structure of FIG. 14 may be configured to be structurally similar or the same as the arrangement structure of FIG. 9 where no dummy pattern is disposed within a reference proximity to the first antenna 200 and a dummy pattern is disposed within a reference proximity to the second antenna 300. Accordingly, the arrangement structure of FIG. 14 described above can acquire similar or the same test results as the improved results of isolation shown in FIG. 11, and also it can be expected that isolation between the two antennas, the first antenna 200 and the second antenna 300, increases from 10 dB to 25.6 dB in the GPS band.

Accordingly, the length h by which the first dummy pattern 410 overlaps the first antenna 200 or by which the second dummy pattern 420 overlaps the second antenna 300 may be set to a length below a reference threshold, such as a minimum length, in which coupling can occur. A distance between the first dummy pattern 410 and the first antenna 200 or a distance between the second dummy pattern 420 and the second antenna 300 may be set to a distance above a reference threshold, such as a maximum distance, at which coupling can occur. Also, a distance between at least one of the first dummy pattern 410 and the second dummy pattern 420 and the main ground 100 may be set to a distance below a reference threshold, such as a minimum distance, at which coupling can occur.

Generally, antennas may be designed to be spaced away from a ground, and radiation may be generated from the ends of the antenna patterns. However, since the first dummy pattern 410 and the second dummy pattern 420 do not operate as antennas, the first dummy pattern 410 and the second dummy pattern 420 may be disposed in a reference distance from the main ground 100 to move a resonance frequency band to a lower band, to reduce the lengths of the first dummy pattern 410 and the second dummy pattern 420 to a lower reference limit, to reduce coupling lengths of at least one of the first dummy pattern 410 and the second dummy pattern 420 with at least one of the first antenna 200 and the second antenna 300, and to increase a distances between at least one of the first dummy pattern 410 and the second dummy pattern 420 and at least one of the first antenna 200 and the second antenna 300. Accordingly, a resonance bandwidth of the GPS frequency band may be narrowed to reduce interference with respect to peripheral frequency bands.

The switching device 500 may be a radio frequency (RF) switch device, such as a diode, a transistor, a Field Effect Transistor (FET), a Micro Electro Mechanical Systems (MEMS), and a Complementary Metal Oxide Semiconductor (CMOS) switch device, which can perform a switching operation.

As described above, in the terminal with the plurality of antennas, by disposing is one or more of dummy patterns, which may provide a third resonance in a resonance frequency band of an interfered antenna among multiple antennas supporting different frequency bands, within a reference proximity to at least one of an interfering antenna and the interfered antennal so that a dummy pattern may be coupled with at least one of the interfering antenna and the interfered antenna, it may be possible to improve isolation of a resonance frequency band of the interfered antenna without influencing a resonance of the interfering antenna to improve the performance of the interfered antenna. Also, by selectively connecting/disconnecting at least one of dummy patterns, including the first dummy pattern 410 and the second dummy pattern 420, to/from the main ground 100, it may be possible to increase the efficiencies of at least one of the first antenna 200 and the second antenna 300 according to the frequency band characteristics of the first antenna 200 and the second antenna 300. Accordingly, the communication quality of the terminal may be increased according to a given communication environment.

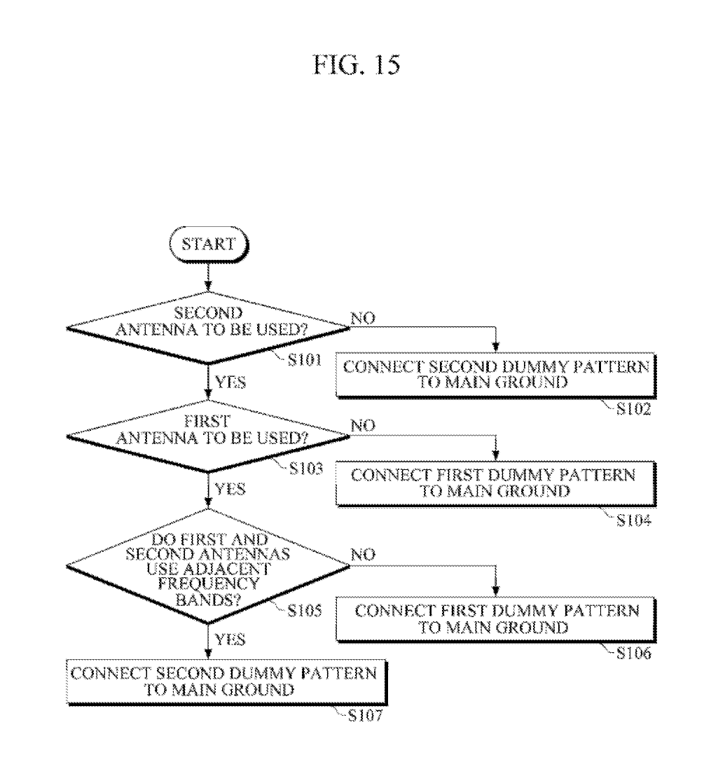

FIG. 15 is a flowchart illustrating a method for connecting a first dummy pattern and a second dummy pattern of a terminal to a main ground according to an exemplary embodiment of the present invention.

Referring to FIG. 15, a scenario of connecting at least one of the first dummy 410 and the second dummy pattern 420 to the main ground 100 will be described below. In operation 101, the terminal determines whether the second antenna 300 is to be used, and if the second antenna is determined not to be used, the switch unit 500 connects the second dummy pattern 420 to the main ground 100 in operation 102. If the second antenna 300 is determined to be used, the terminal determines whether the first antenna 200 is to be used in operation 103, and if the first antenna 200 is determined not to be used, the switching device 500 connects the first dummy pattern 410 to the main ground 100 in operation 104.

If both the first antenna 200 and the second antenna 300 are to be used, the terminal determines whether the first antenna 200 and the second antenna 300 use frequency bands that are adjacent to each other in operation 105. If the mobile terminal determines that first antenna 200 and the second antenna 300 do not use adjacent frequency bands, the switching device 500 connects the first dummy pattern 410 to the main ground 100 in operation 106. If the mobile terminal determines that the first antenna 200 and the second antenna 300 use adjacent frequency bands, the switching device 500 connects the second dummy pattern 420 to the main ground 100 in operation 107.

According to the exemplary embodiments of the present invention, in a terminal with multiple antennas that support different frequency bands, a dummy pattern may be disposed within a reference proximity to an interfering antenna or an interfered antenna so that isolation with respect to a resonance frequency band of the interfered antenna may be improved without influencing resonance of the interfering antenna, thereby resulting in improvement of antenna performance.

Also, since a third resonance with respect to a specific frequency band may be provided in the state where one side of each antenna is disposed within a reference proximity to one side of a shared ground, interference between antennas may be decreased to improve isolation between the antennas without providing separate grounds for individual antennas.

In addition, by selectively connecting/disconnecting a dummy pattern to a main ground to increase the efficiency of an antenna according to frequency band characteristics of the antenna, it may be possible to maintain the performance of antennas of a terminal while increasing communication quality of the terminal in a given communication environment.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a main ground disposed on a substrate;
a first antenna connected to the main ground;
a second antenna spaced apart by a reference distance from the first antenna and connected to the main ground; and
a dummy pattern disposed within a reference proximity to at least one of the first antenna and the second antenna.

2. The terminal of claim 1, wherein the dummy pattern is coupled with the at least one of the first antenna and the second antenna to provide a resonance.

3. The terminal of claim 1, wherein the first antenna supports a first frequency range and the second antenna supports a second frequency range.

4. The terminal of claim 3, wherein the first frequency range and the second frequency range are adjacent to one another.

5. The terminal of claim 1, wherein the first antenna supports a Long Term Evolution (LTE) frequency band.

6. The terminal of claim 1, wherein the second antenna supports a Global Positioning System (GPS) frequency band.

7. The terminal of claim 1, wherein the dummy pattern provides a third resonance in a resonance frequency band of the second antenna.

8. The terminal of claim 1, wherein the dummy pattern provides a third resonance based on an inductance and a capacitance of the dummy pattern, in which the inductance is based on a length of the dummy pattern.

9. The terminal of claim 8, wherein the capacitance is based on a first distance between the dummy pattern and the main ground, and a second distance between the dummy pattern and the first antenna.

10. The terminal of claim 8, wherein the capacitance is based on a first distance between the dummy pattern and the main ground, and a second distance between the dummy pattern and the second antenna.

11. The terminal of claim 1, wherein a length of the dummy pattern overlapping an antenna coupled to the dummy pattern is directly related to a width of a resonance frequency band of the second antenna.

12. The terminal of claim 1, wherein a distance between the dummy pattern and an antenna coupled with the dummy pattern is inversely related to a width of a resonance frequency band of the second antenna.

13. The terminal of claim 1, wherein if the dummy pattern is coupled to the first antenna, at least one of a resonance provided by the first antenna, a resonance provided by the second antenna, and a third resonance provided by the dummy pattern reduces antenna radiation of the first antenna with respect to a resonance frequency of the second antenna.

14. The terminal of claim 1, wherein if the dummy pattern is coupled to the second antenna, an increase in attenuation of a resonance of at least one of the first antenna and the second antenna improve isolation therebetween.

15. The terminal of claim 1, wherein the dummy pattern is disposed in a direction in which the main ground extends.

16. The terminal of claim 1, wherein the dummy pattern is disposed in a direction perpendicular in which the main ground extends.

17. A terminal, comprising:
a main ground disposed on a substrate;
a first antenna connected to the main ground;
a second antenna spaced apart by a reference distance from the first antenna and connected to the main ground;
a first dummy pattern disposed within a reference proximity to the first antenna;
a second dummy pattern disposed within a reference proximity to the second antenna; and
a switching device to turn on at least one of the first dummy pattern and the second dummy pattern.

18. A method for improving isolation, comprising:
determining whether a first antenna is to be used;
determining whether a second antenna is to be used;
determining whether the first antenna and the second antenna of a terminal uses adjacent frequency bands; and
connecting a dummy pattern corresponding to at least one of first antenna and the second antenna to a main ground,
wherein the dummy pattern is connected according to the determinations.

19. The method of claim 18, wherein the dummy pattern is disposed in a direction perpendicular in which the main ground extends.

20. The method of claim 18, wherein if only the second antenna is used among the first antenna and the second antenna, a dummy pattern corresponding to the first antenna is connected to the main ground.

21. The method of claim 18, wherein if only the first antenna is used among the first antenna and the second antenna, the dummy pattern corresponding to the second antenna is connected to the main ground.

22. The method of claim 18, wherein if a frequency band of the first antenna is closer to a frequency band of the second antenna, the switching device connects the dummy pattern corresponding to the second antenna to the main ground.

23. The method of claim 18, wherein, if a frequency band is not in use or is outside of a reference range of a frequency band of the second antenna, the switching device connects the dummy pattern corresponding to the first antenna to the main ground.
